(19) United States
(12) Patent Application Publication
(10) Pub. No.: US 2024/0300837 A1
(43) Pub. Date: Sep. 12, 2024

(54) VOLUME REDUCTION SOLIDS TREATMENT SYSTEM

(71) Applicants: Georgia Tech Research Corporation, Atlanta, GA (US); Duke University, Durham, NC (US)

(72) Inventors: Shannon YEE, Decatur, GA (US); Dante DIMENICHI, III, Smyrna, GA (US); Wiley D. HOLCOMBE, Decatur, GA (US); Jonathan HOLMES, Roswell, GA (US); Alexis NOEL, Sandy Springs, GA (US); Kyle AZEVEDO, Brookhaven, GA (US); Ryan GAYLO, Canton, GA (US); Stephanie RICHTER, Atlanta, GA (US); Travis TURNER, Atlanta, GA (US); Kristine SHERMAN, Smyrna, GA (US); Brian HAWKINS, Durham, NC (US); Graham MILLER, Durham, NC (US); Lena TROTOCHAUD, Durham, NC (US)

(21) Appl. No.: 18/578,262

(22) PCT Filed: Jul. 15, 2022
(86) PCT No.: PCT/US2022/073813

§ 371 Date: Jan. 10, 2024

Related U.S. Application Data
(60) Provisional application No. 63/222,740, filed on Jul. 16, 2021.

(51) Int. Cl. C02F 11/122; C02F 11/13; C02F 11/18; C02F 103/00

(52) U.S. Cl. CPC C02F 11/122; C02F 11/13; C02F 11/185; C02F 2103/005; C02F 2209/02; C02F 2209/36; C02F 2209/44; C02F 2303/04

(57) ABSTRACT

System and method for volume reduction solids treatment for fecal waste are described. The system can include a pasteurizer (102) configured to receive a slurry batch and heat the slurry batch at an elevated temperature for a time period to produce a pathogen free slurry. The system can also include a mechanical dewatering press (104) configured to compress the pathogen free slurry to separate a liquid phase from a volume reduced solid waste. The volume reduced solid waste being formed into a feces cake. The system can also include a means to remove the liquid phase and a drying tunnel (106) comprising a conveyor housed and an air duct system. The air duct system configured to propel forced air over the feces cake.

### CROSS-REFERENCE TO RELATED APPLICATION

This application claims the benefit of and priority to U.S. Provisional Application No. 63/222,740, titled “VOLUME REDUCTION SOLIDS TREATMENT SYSTEM,” filed on Jul. 16, 2021, the entire contents of which are hereby incorporated herein by reference.

### BACKGROUND

An estimated 4.5 billion people worldwide do not have access to safe, affordable sanitation systems. High levels of child death and disease have been linked to oral fecal contamination where pathogen laden fecal matter enters the food or water supply. Non-sewered sanitation systems are needed where traditional sanitary sewer systems are unavailable or impractical.

### SUMMARY

Disclosed herein is a solids waste treatment system comprising a pasteurizer, a mechanical dewatering press, an outlet to remove a liquid phase following treatment, and a drying tunnel. The pasteurizer is configured to receive a slurry batch and heat the slurry batch at an elevated temperature for a time period to produce a pathogen free slurry, the slurry batch comprising at least feces. The mechanical dewatering press is configured to compress the pathogen free slurry to separate a liquid phase from a volume reduced solid waste, the volume reduced solid waste being formed into a feces cake. The drying tunnel comprises a conveyor housed in an air duct system, the air duct system configured to propel forced air over the feces cake in the drying tunnel. Also disclosed is a process for treatment of human waste using the disclosed solids waste treatment system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates an example diagram of a volume reduction solids treatment system according to various embodiments described herein.

FIGS. 2A and 2B illustrate example back and front views of the volume reduction solids treatment system of FIG. 1 according to various embodiments described herein.

FIGS. 3A and 3B illustrate an example pasteurizer of the volume reduction solids treatment system of FIG. 1 according to various embodiments described herein.

FIGS. 4A-4D illustrate an example filter press of the volume reduction solids treatment system of FIG. 1 according to various embodiments described herein.

FIG. 5 illustrates an example of the drying tunnel of the volume reduction solids treatment system of FIG. 1 according to various embodiments described herein.

FIGS. 6A and 6B illustrate an example concentrator of the volume reduction solids treatment system of FIG. 1 according to various embodiments described herein.

FIG. 7 illustrates an example method for volume reduction of solids according to various embodiments described herein.

FIG. 8 illustrates an example schematic of the volume reduction solids treatment system used as a module within a non-sewered single unit toilet system according to various embodiments described herein.

### DETAILED DESCRIPTION

Sanitation systems are needed for regions of the world where open defecation or lack of improved sanitation is common, which can lead to illness. Traditional sewage and wastewater treatment plants which receive waste from sewers can be expensive to implement and operate. Technologies for multi-unit toilets are being developed to process waste on a large scale. However, there is a need for technology to provide access to safe, affordable sanitation systems that can be deployed in a family home without sewer connections. Holistically, as water scarcity rises across the globe, sanitation systems that reduce reliance on large volumes of water for transport of waste over long distances will become increasingly important, not just in developing countries, but globally.

To address these deficiencies, systems for use in a stand-alone non-sewered toilet system are discussed herein. The systems can be configured to inactivate pathogens from human waste and prepare the waste for safe disposal. The systems can also recover valuable resources such as clean water. The systems can be configured to operate without connection to input water or output sewers. Some example systems can be battery based or powered by off-grid renewables. The systems can be optimized for low-cost fabrication and low operation costs. The systems can promote sustainable sanitation services that operate in poor, urban settings, as well as in developed and developing nations.

The ISO 30500 standard provides a technical standard for non-sewered sanitation systems designed to address basic sanitation needs and promote economic, social, and environmental sustainability through strategies that include minimizing water and energy consumption, and converting human excreta to safe output. These sanitation systems are intended to operate without connection to any sewer or drainage network and meet health and environmental safety and regulatory parameters. In some examples, systems described herein can be configured to provide treated output that meets or exceeds the ISO 30500 standard.

For example, human waste streams can include urine, feces, diarrhea, and the like. Sanitation incidentals can include toilet paper, feminine hygiene waste, diapers, other paper products, and the like. In some toilet systems, a portion of sanitation incidentals, including non-organic products such as diapers, can be received and processed separately from the human waste streams. In some examples, the wastes streams comprise human feces and urine, menstrual blood, bile, flushing water, anal cleansing water, toilet paper, other bodily fluids and/or solids. Additionally, the waste streams can comprise water, including flush water, rinse water, wash water, fresh water, consumable water, potable water, useable water, and the like.

For example, a stand-alone non-sewered toilet system can comprise a liquid treatment system and a solids treatment system, each of which can operate as a separate system or be interconnected for treatment of human waste. The stand-alone non-sewered toilet system can also comprise at least one separation system. In some examples, the content of human waste streams can be separated or processed separately. Separation of streams can provide more efficient processing than mixed-content human waste streams by dividing the source material into primarily feces, urine, and wastewater streams. Since 100% separation is not practical, a degree of cross contamination between the streams is acceptable for the subsequent downstream treatment approaches. As described herein, the feces stream, containing primarily feces, is also referred to as the “brown stream.” The brown stream is mostly feces, but can also be mixed with other liquid and solid waste. For example, the brown stream can include feces, toilet paper, some urine, and some water. As described herein, the “green stream” can include mostly water, some urine, and some toilet paper, and usually does not include feces. The green stream is mostly liquid with some solids. As described herein, the urine stream, containing primarily urine, is also referred to as the “yellow stream.” For example, a yellow stream can include urine and some water. As described herein, the wastewater stream is also referred to as the “blue stream.” For example, the blue stream can contain primarily wastewater in the form of flush water, anal rinse water, or excess water that is poured into the toilet. In some examples, the blue stream can also include some urine. Stream separation can enable lower cost and more robust treatment processes given the high degree of variability in low volume fecal deposits (recognized as primarily diarrhea), high volume urine deposits, and excessive amounts of flush and anal rinse water, given future water scarcity constraints.

In the context described above, various examples of systems and methods for volume reduction solids treatment for fecal waste streams are described herein. The volume reduction solids treatment system is a solids treatment system that can operate separately or be configured for use in a stand-alone non-sewered toilet system. The fecal waste streams can comprise feces, as well as urine, water, and other sanitation incidentals contained in a waste stream collected in a toilet system. The volume reduction solids treatment system can be integrated as a module for solids treatment in a stand-alone non-sewered sanitation system. For example, a volume reduction solids treatment module can be integrated for use in a single unit toilet system configured to render the bodily wastes of an adult human into water, CO₂, and mineral ash. In some examples, the volume reduction solids treatment system can be configured to provide treated output that meets or exceeds the ISO 30500 standard.

The volume reduction solids treatment system can be used to process a feces stream or brown stream of human waste. By separating the brown stream prior to input into the volume reduction solids treatment system, the system can operate to process the solids contained therein. Moreover, a brown stream slurry can be obtained by removing excess fluid from the brown stream and homogenizing the contents. For example, a brown stream slurry can be obtained in a system or module external to the volume reduction solids treatment system. In an example, a brown stream can be received into a collection tank and processed into a slurry. In an example, the collection tank can be a stream mixing vessel to receive more than one waste stream.

The method and system for volume reduction solids treatment can include a pasteurization and volume reduction process for the treatment of human waste in a toilet environment to produce pathogen free feces cakes suitable either for combustion and reduction to ash or disposal by other means. In some examples, the volume reduction solids treatment system can operate as part of a single unit toilet system. The feces slurry can pass into a pasteurization heater where it is held at elevated temperatures until pathogen kill is achieved. The treated waste slurry can be transferred at elevated temperatures to a mechanical dewatering filter press. The treated slurry can then be compressed, and the volume reduced solid waste can be ejected from the filter press as a feces cake onto a conveyor. The change in volume of the input slurry to the feces cake output can be evaluated in terms of change in water content. For example, the input slurry moisture content can be 96-99% and the output pressed cake moisture content can be 28-84%. This reduction in water content corresponds to at least an 80% reduction in volume. The reduction in volume can be greater than 95%.

In an example, the removed liquid phase can be transported out of the system for treatment in a separate liquid treatment system. In an example, the conveyor can transport the feces cakes to the disposal bin over a period of 8-10 hours. In an example, the conveyor can be housed in a drying tunnel. The drying tunnel being a contained air duct system to enable forced air to be propelled over the feces cakes to provide evaporative drying of the feces cakes during transport. The final cakes can have 4-10% moisture content and be deposited in a removable bin for subsequent disposal. In an example, the feces cakes can be reduced to ash in an external combustion system.

In the following discussion, a general description of the volume reduction solids treatment systems and their components is provided, including a discussion of the operation of the same. Non-limiting examples of a volume reduction solids treatment system are discussed. In some examples, the configuration can include optional connections to integrate the volume reduction solids treatment system with other systems comprising a stand-alone non-sewer sanitation system. For example, the volume reduction solids treatment system can integrate with a urine and wastewater treatment system.

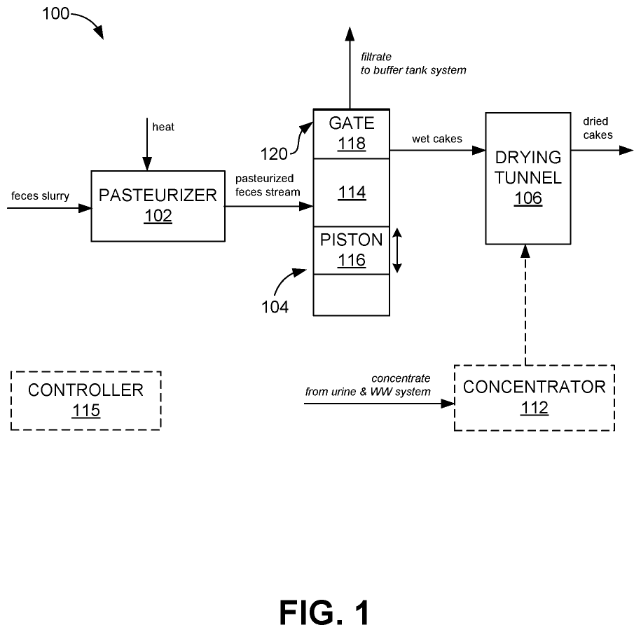

As shown in FIG. 1, the volume reduction solids treatment system 100 can include a pasteurizer 102, a filter press 104, and a drying tunnel 106. The volume reduction solids treatment system 100 is configured to receive a feces slurry and produce feces cakes that are pathogen free. The volume reduction solids treatment system 100 can also comprise a controller 115 to operate the valves, pumps, motors, actuators, switches, and sensors (not shown). The feces slurry is a slurry that comprises feces, but can include other waste. As described herein, the feces slurry can be a brown stream slurry, that can include feces, urine, toilet paper, and/or water. The feces slurry can be received from a separate system that comprises a homogenizer to break down the solid waste to a uniform particle size. For example, the homogenizer can be a macerator or grinder, and the like. In some examples, the feces slurry can be received from a system that separates liquids and solids from a mixed-content human waste stream. In some examples, the feces slurry can be received from a buffer tank that holds solids waste.

A batch of feces slurry can be received into the pasteurizer 102. In some examples, a batch of feces slurry can be received directly from a separation and homogenization system or another system comprising a homogenizer that forms the feces slurry from solids separated from a human waste stream. The batch of feces slurry can be heated in the pasteurizer 102 at an elevated temperature for a period of time sufficient to kill pathogens. For example, the elevated temperature can be at least 85° C. For example, the batch of feces slurry can be treated in the pasteurizer 102 for about 10 min at about 95° C. The treated output from the pasteurizer 102 can be a pathogen free or pathogen reduced feces slurry. In an example, the pasteurizer 102 can process 6L a day of feces slurry in 100 mL batches to achieve pathogen reduction. In some examples, the treated slurry output of the pasteurizer is ISO 30500 compliant.

The treated slurry can be delivered from the pasteurizer 102 to the filter press 104. The filter press 104 can be a mechanical dewatering filter press that comprises a solids chamber 114, a piston 116, and a filter gate 118. The filter press 104 can receive the treated slurry, also called a pasteurized brown stream herein, into a solids chamber 114. The filter press 104 is configured to actuate a piston 116, reducing the volume of the solids chamber 114, and compressing the treated slurry against the filter gate 118 to form a feces cake. The filter gate 118 comprises a filter screen 120. For example, the filter screen 120 can be filter screen can be 41-160 μm nylon net, 140-508 μm stainless steel mesh, or other perforated plate. For example, the filter screen 120 can be a 508 μm stainless steel mesh filter. Compressing the treated slurry can extract liquids from the slurry, which can be output via filter gate 118. The extracted liquid, or filtrate, can be collected. In some examples, the filtrate can be delivered to a separation and homogenization system to separate particulates.

The filter gate 118 can translate to shear the feces cake off the filter and open the chamber, ejecting the feces cake. In an example, a squeegee 122 can be driven by a motor 124 and belt drive 125 to deliver the wet feces cake to a drying tunnel 106. The drying tunnel 106 can comprise a dryer belt or conveyor 130. The drying tunnel 106 can reduce the moisture content of the filter cakes thru the sticky phase to a level that will allow release from the belt and solids container. In an example, the drying tunnel 106 can comprise conveyor 130 housed in a contained air duct system 134 configured to propel forced air over the feces cakes to provide evaporative drying of the feces cakes during transport. For example, the conveyor 130 can transport the feces cakes to a disposal bin 132 over a period of 2-3 hours.

In some examples, the volume reduction solids treatment system 100 can also comprise a concentrator 112 or interface with a concentrate tank of a liquids treatment system. The concentrator can be a pasteurization and evaporation module. For example, the mixed waste can be separated into liquids and solids prior to input to the volume reduction solids treatment system 100. The liquids treatment system can output rejected fluids that contain solids and cannot be treated in the liquids treatment system. The rejected fluids can be reduced in volume by heating the fluids in the concentrator 112. In an example, pressurized air can be introduced into the concentrator such that humidified air and/or an off gas is released, and a concentrate remains. The condensed effluent or concentrated volume can be delivered to the drying tunnel 106 to remove remaining moisture content. In an example, the drying tunnel 106 can receive a concentrate from a liquids treatment system. For example, the drying tunnel 106 can evaporate up to 4 L/day or more of concentrate. In some examples, the drying tunnel 106 can further comprise a means to discharge gas.

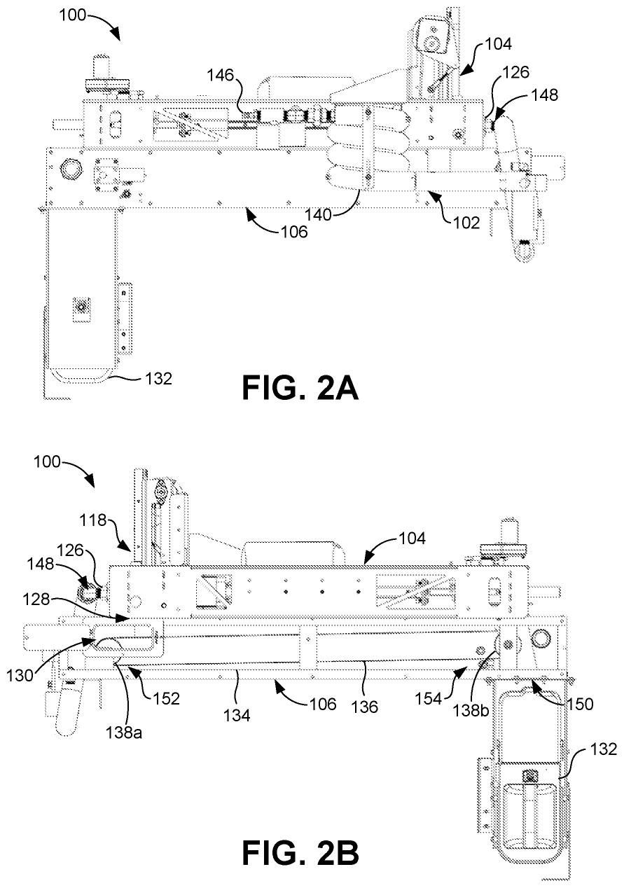

FIGS. 2A and 2B illustrate rear and front views of an example volume reduction solids treatment system 100 of FIG. 1. In this space saving example, a feces slurry is received into the pasteurizer inlet 146 and flows through the tubing 140 of the pasteurizer 102 to the pasteurizer outlet 148. The pasteurizer outlet 148 is in fluid communication with the filter press inlet 126. After pasteurization, the treated slurry can be delivered via the pasteurizer outlet 148 to the filter press 104. The filter press 104 can operate to form the feces cakes to be released from a filter press outlet 128. The feces cakes can be conveyed on in the drying tunnel 106 for a period of time to be released via a drying tunnel outlet 150 (FIG. 2B) to the disposal bin 132.

As shown in FIG. 2B, the drying tunnel 106 can comprise dryer belt 136 housed in a contained air duct system 134 to force air over the feces cakes (not shown) to provide evaporative drying of the feces cakes during transport. The drying tunnel 106 having a proximal end 152 and a distal end 154, with the dryer belt 136 extending about rollers 138a, 138b positioned at each of the proximal and distal ends 152, 154. The dryer belt 136 is configured to convey the feces cake from where the feces cake is delivered from the filter press 104 the proximal end 152 to the distal end 154, where the feces cake is released into a solids disposal bin 132. In some examples, the dryer belt 136 is arranged with an incline from the proximal end 152 to the distal end 154. In some examples, the dryer belt 136 can comprise a mesh to allow air flow. For example, the dryer belt 136 can be made of a polymer mesh or a metal mesh. As shown in this example, the volume reduction solids treatment system 100 can also include a solids disposal bin 132 to receive the dried or mostly dried feces cakes. The feces cakes can be transferred in the disposal bin 132 by user to a combustor or suitable system for reduction to ash or disposal by other means.

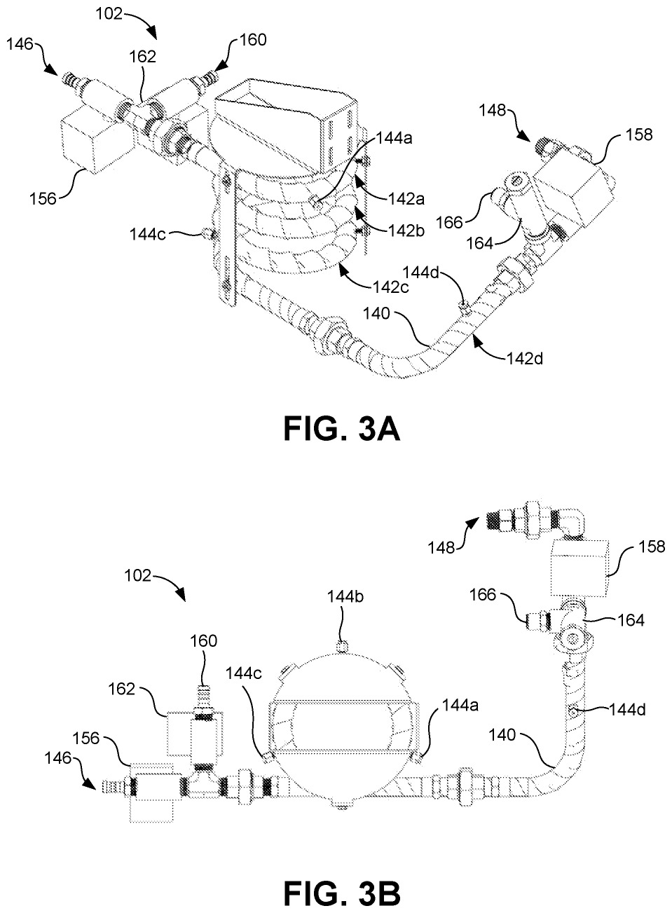

FIGS. 3A and 3B illustrate the example pasteurizer 102 of FIG. 2A in greater detail. The pasteurizer 102 can include tubing 140 and one or more heaters 142a-d (separately “heater 142,” collectively “heaters 142”). For example, the feces slurry can be received into the tubing 140 at the pasteurizer inlet 146, heated by the heaters 142a-d at an elevated temperature for a period of time sufficient to kill pathogens, with the treated slurry output through the pasteurizer outlet 148. In this example, a heater 142 can be a heater wrap configured to surround the tubing, although other types and configurations of heaters can be relied upon and implemented. Valve 156 at the pasteurizer inlet 146 and valve 158 at the pasteurizer outlet 148 can each be configured to control the flow of the slurry through the respective pasteurizer inlet 146 or pasteurizer outlet 148. The pasteurizer 102 can also include a flush water inlet 160 and valve 162 configured to receive an input of water for flushing of the tubing 140. For example, valves 156, 158, 162 can be two-way valves. The pasteurizer 102 can also include a pressure release valve 164 and a rupture pressure outlet 168 to protect the pasteurizer 102 during an overpressure event.

For example, the batch of feces slurry can be treated in the pasteurizer 102 for about 10 min at about 95° C. In an example, the heaters 142 can be independently controlled to enable more energy efficient heating. For example, a plurality of zones can be formed along the length of the tubing using a plurality of heaters 142 with independent temperature control. As an example, as shown in FIG. 3A, the one or more heaters 142a-142d can be a plurality of sections of heater wrap wrapped around the tubing 140, forming a plurality of heating zones independently controlled via a plurality of control thermocouple ports 144a-d (separately “thermocouple port 144,” collectively “thermocouple ports 144”). In this example, thermocouple ports 144 are shown for temperature control, although other types and configurations of devices to measure and control temperature of the heaters 142 can be relied upon and implemented. In an example, the pasteurizer can be configured such that the output meets an ISO 30500 required pathogen reduction. For example, the Escherichia coli (E. coli) counts in final solid output can be less than 100 per g. In some examples, the E. coli counts can range from 19 to 2395 per g material. In some examples, the E. coli counts can be below detection limits.

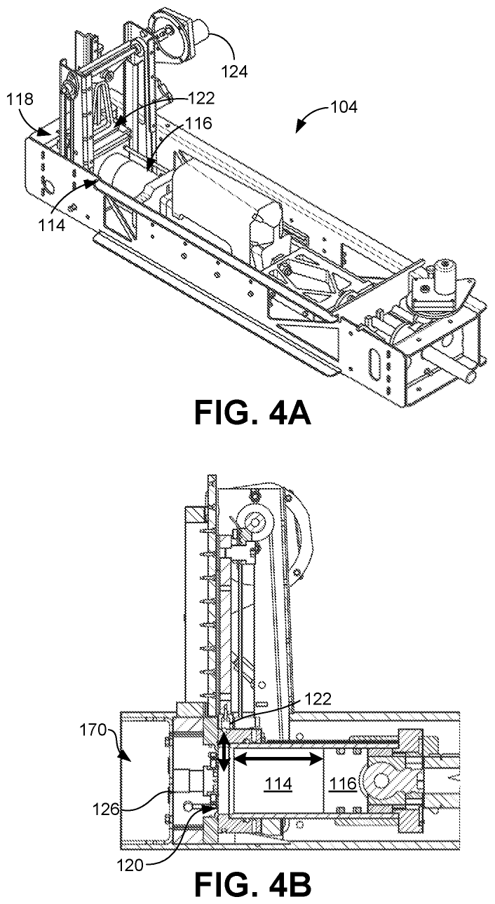

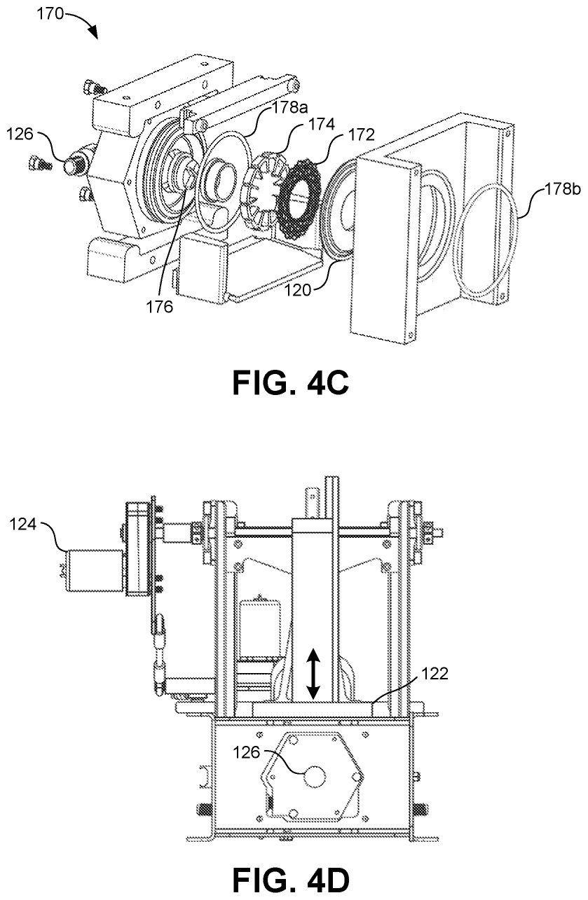

FIGS. 4A-4D illustrate the example filter press 104 of FIG. 2A in greater detail. The treated slurry can be received into a solids chamber 114 of the filter press 104. The solids chamber 114 can be cylindrical in shape and configured to receive the piston 116. The piston 116 can be actuated to reduce the volume of the solids chamber 114 and apply pressure to the treated slurry against the filter gate 118 to form a feces cake. The extracted fluid can pass through the filter gate 118 to be collected or delivered to another treatment system. The feces cake can be released to the drying tunnel 106 via a filter press outlet 128.

FIG. 4B illustrates a cross sectional view of a portion of the filter press 104 of FIG. 4A. The treated slurry can be received into a solids chamber 114 of the filter press 104 via the filter press inlet 126. As indicated by the horizontal arrow, the piston 116 can compress the slurry against filter screen 120 to form a cake.

FIG. 4C illustrates an exploded view of the filter assembly 170 of the filter gate 118. The filter assembly 170 comprises a filter screen 120, a filter support screen 172, a drain spacer 174, the filter press inlet 126, and a check valve 176. The filter assembly 170 can also include seals 178a, 178b for the filter assembly 170. The slurry can be received via the filter press inlet 126 and introduced into the solids chamber 114 via a check valve 176. As indicated by the vertical arrow shown in FIG. 4D, the squeegee 122 can translate to remove the feces cake from the filter screen 120 to release the feces cake to the drying tunnel 106.

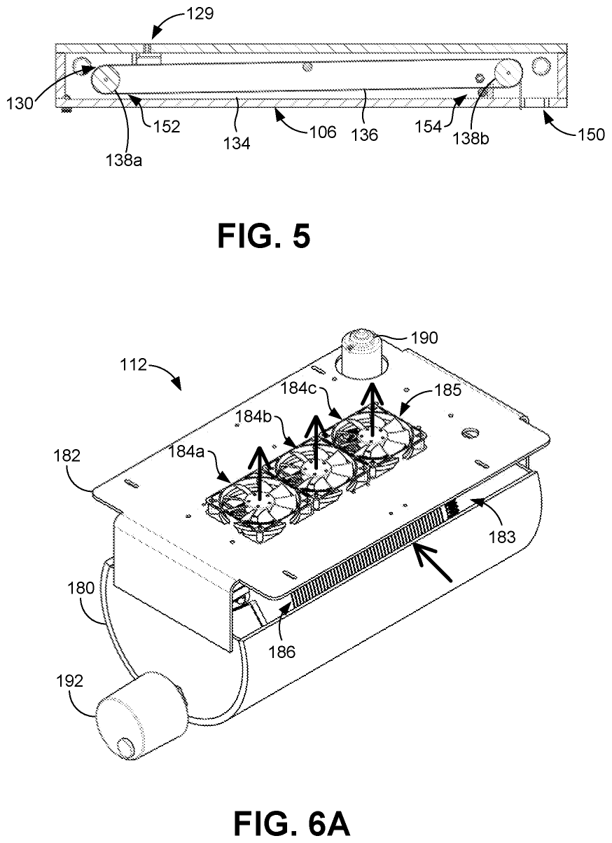

FIG. 5 illustrates a cross section of the drying tunnel 106 shown in FIG. 2B in greater detail. The feces cakes can be received from the filter press 104 via a drying tunnel inlet 129. The drying tunnel 106 is configured to force air over the feces cakes (not shown) to provide evaporative drying of the feces cakes during transport. The drying tunnel 106 having a proximal end 152 and a distal end 154, with the dryer belt 136 extending about rollers 138a, 138b positioned at each of the proximal and distal ends 152, 154. The dryer belt 136 is configured to convey the feces cake from where the feces cake is delivered from the filter press 104 the proximal end 152 to the distal end 154, where the feces cake is released via the drying tunnel outlet 150. In some examples, the drying tunnel 106 can also receive solids output separately from the concentrator 112.

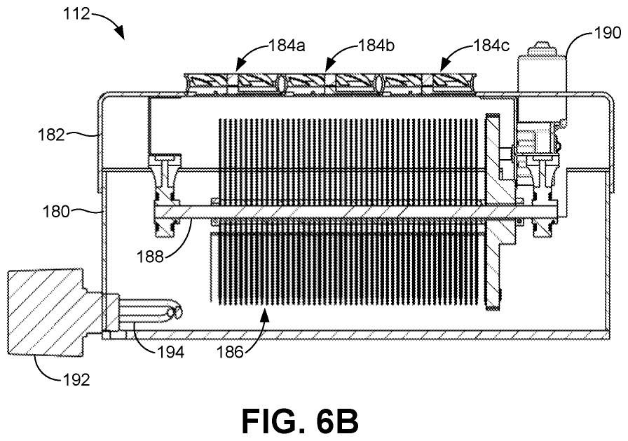

When volume reduction solids treatment system 100 is part of a non-sewered single unit toilet system, the concentrator 112 can receive rejected fluids containing salts and/or other particulate solids from a liquids treatment system. FIGS. 6A and 6B illustrate the concentrator 112 of the volume reduction solids treatment system 100. The concentrator 112 can be a pasteurization and evaporation module that can interface with a concentrate tank of a liquids treatment system. For example, the liquids treatment system can output rejected fluids that contain solids and cannot be treated in the liquids treatment system. The rejected fluids can be reduced in volume by heating the fluids in the concentrator 112. In an example, pressurized air can be introduced into the concentrator such that humidified air and/or an off gas is released, and a concentrate remains.

As shown in FIG. 6A, the concentrator 112 can comprise an open concentrator vessel 180 configured to hold a volume of fluid and a plurality of discs 186 housed within the open concentrator vessel 180. As shown in the cross-sectional view in FIG. 6B, the plurality of discs 186 can be arranged about an axle 188 that can be rotated by a motor 190 such that at least a portion of the plurality of discs can be wetted by the fluid as the axle 188 rotates. A heater 192 can comprise heating coils 194. The heater 192 can be positioned such that heating coils 194 extend into the open concentrator vessel 180 and are configured to heat the volume of fluid contained within the open concentrator vessel 180. In some examples, the concentrator module 112 can also include an enclosure 182 positioned over the open concentrator vessel 180. In some examples, the concentrator module 112 can further comprise an air intake 183 and an air outlet 185 to provide air flow over the plurality of discs 166, that are wet, to aid in evaporation of the fluids to be concentrated. For example, a blower (not shown) or one or more fans 184 can direct air flow through the concentrator 112. As shown in FIG. 6A, the enclosure 182 can comprise one or more fans 184a-c (separately “fan 184,” collectively “fans 184”) positioned to draw air through the concentrator vessel 180 and over the plurality of discs 166. The air intake 183 can be at a gap between the open concentrator vessel 180 and an enclosure 182. In another example, a system blower (not shown) can provide airflow in a similar manner over the plurality of discs 166 to aid in evaporation of the fluids to be concentrated.

The concentrator 112 can receive a can receive a volume of rejected fluids containing salts and/or other particulate solids from a liquids treatment module. The volume of fluid can be contained by the open concentrator vessel 180. The volume of fluid can be maintained at a level that does not flow over or interfere with the rotation of the axle 188. The volume of fluid can be heated by the heater 192 and heating coils 194 to aid in evaporation of the fluid. As the plurality of discs are rotated through the heated volume of fluid, the air intake 183 can be configured to direct air into the concentrator 112 over the plurality of discs 186 such that the fluid evaporates leaving the solids of the fluid received. The arrows shown in FIG. 6A indicate a direction of air flow for evaporation in one example. In another example, the air intake 183 and air outlet 185 can be reversed such that the air flow is provided in the opposite direction. For example, the fans 184 can be configured to draw air through the concentrator 112 or to operate in a reverse direction to blow air into the concentrator 112 and out the gap between the open concentrator vessel 180 and an enclosure 182.

In one example, the condensed effluent or concentrated volume can be delivered to the drying tunnel 106 to remove remaining moisture content. In an example, the drying tunnel 106 can receive a concentrate from the concentrator 112. For example, the drying tunnel 106 can evaporate up to 4 L/day or more of concentrate. In some examples, the drying tunnel 106 can further comprise a means to discharge gas. In another example, up to 50% of the volume contained within the open concentrator vessel 180 can be returned to a buffer tank system or other treatment module for further processing.

Although not shown in the figures, the volume reduction solids treatment system 100 can further comprise valves, pumps, motors, actuators, conduit, switches, sensors, and the like. The volume reduction solids treatment system 100 can also comprise a controller 115 (FIG. 1) to operate the valves, pumps, motors, actuators, switches, and sensors. For example, the controller 115 can be connected to a sensor in the pasteurizer 102 to monitor the temperature and control the heater wraps 142 of the pasteurizer 102.

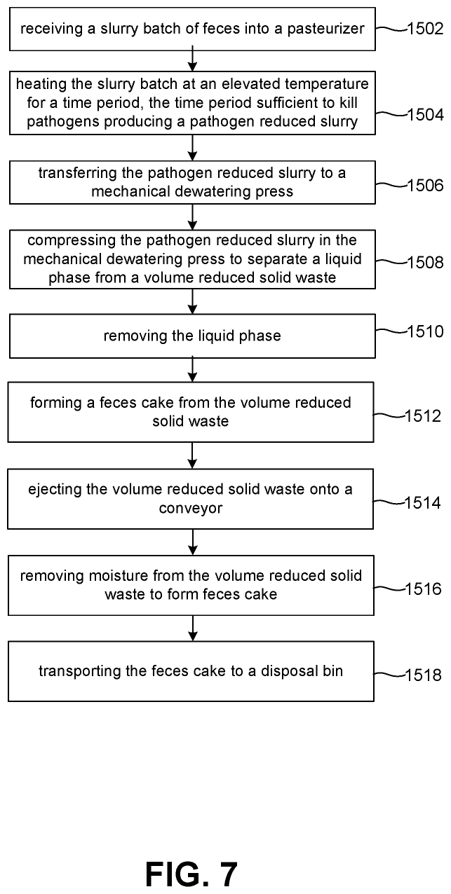

FIG. 7 illustrates an example method for volume reduction of solids as described herein. At box 1502, the method can include receiving a slurry batch of feces into a pasteurizer. For example, the slurry can be received from a homogenizer or a system comprising a homogenizer, such as a separation and homogenization system. In another example, the slurry can be received into a buffer tank and delivered in batches to the pasteurizer.

At box 1504, the method can include heating the slurry batch at an elevated temperature for a time period. The time period can be sufficient to kill pathogens producing a pathogen reduced slurry. For example, the temperature of at least 850 can be maintained for about 10 minutes to kill the pathogens.

The pathogen reduced slurry can be transferred to a mechanical dewatering press at box 1506. The dewatering press can include a chamber to receive the pathogen reduced slurry and a piston to apply pressure and reduce the volume of the chamber. At box 1508, the method can include compressing the pathogen reduced slurry in the mechanical dewatering press to separate a liquid phase from a volume reduced solid waste. For example, the piston can press the pathogen reduced slurry against a filter to separate the liquid phase from a volume reduced solid waste. At box 1510, the liquid phase can be removed by collecting or directing the liquid to another system. The compression and removal of the liquid can form a feces cake from the volume reduced solid waste at box 1512.

At box 1514, the method can include ejecting the volume reduced solid waste onto a conveyor. The feces cake or cake formed from the reduced solid waste can be wet and/or sticky. At box 1516, the method can include removing moisture from the volume reduced solid waste to form feces cake. The feces cake can be delivered to a drying tunnel where forced air over the feces cake can further dry the feces cake. At box 1518, the method can include transporting the feces cake to a disposal bin. For example, the feces cakes can be transported via a belt or conveyor through the drying tunnel over a period of time.

The volume reduction solids treatment system 100 can be configured for use in various systems and applications. As discussed above, as an example, volume reduction solids treatment system can be a solids treatment system configured for use in a stand-alone non-sewered toilet system. The volume reduction solids treatment system 100 can be configured to operate as part of and integrate with a single unit toilet system, including such systems as a liquid treatment system and/or a separation system.

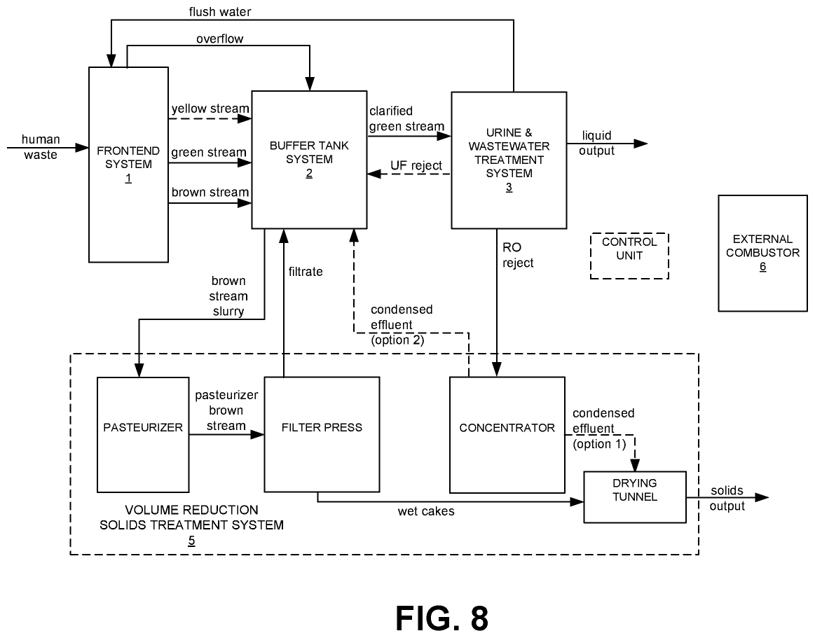

FIG. 8 illustrates an example schematic of a non-sewered single unit toilet system that includes a frontend system 1, a buffer tank system 2, a urine and wastewater system 3, and a volume reduction solids treatment system 5. In this example, the volume reduction solids treatment system 5 can comprise the volume reduction solids treatment system 100 described herein. For example, pasteurizer, filter press, drying tunnel of the volume reduction solids treatment system 5 can be adapted as described herein. As shown in this example, the single-unit toilet system can also include an external combustor 6. For example, an external combustor 6 can also be part of the non-sewered single unit toilet system can be configured to receive the treated solids output from the volume reduction solids treatment system 5.

In this example, the frontend system 1 captures the human waste and to separate the mixed waste stream into at least one of a green stream and a brown stream. In some examples, a yellow stream can also be separated. The separated green, brown, and/or yellow streams can be further processed by a buffer tank system 2. The buffer tank system 2 can be configured to output a clarified green stream to a urine and wastewater treatment system 3 and a brown stream slurry to the volume reduction system 5 which can produce cakes of solid waste comprising feces. The single unit toilet system can further comprise a control unit comprising at least one controller for the operation of the system and/or one or more modules of the system, including valves, pumps, motors, sensors, and other devices. The single unit toilet system can be configured to deliver a treated liquid output and a treated solids output. For example, clean water and/or treated water can be further used in the system for flush water in the frontend 1 or used for processing in one or more of the systems or modules. In some examples, the treated solid waste can be dried or partially dried cakes deposited in a disposal bin for a user to access. The user can transport the dried or partially dried cakes to the external combustor 6 to be burned.

### Aspects

The following list of exemplary aspects supports and is supported by the disclosure provided herein.

Aspect 1. A solids waste treatment system, comprising:
a pasteurizer configured to receive a slurry batch and heat the slurry batch at an elevated temperature for a time period to produce a pathogen free slurry, the slurry batch comprising at least feces;
a mechanical dewatering press configured to compress the pathogen free slurry to separate a liquid phase from a volume reduced solid waste, the volume reduced solid waste being formed into a feces cake;
an outlet to remove the liquid phase; and a drying tunnel comprising a conveyor housed in an air duct system, the air duct system configured to propel forced air over the feces cake in the drying tunnel.

Aspect 2. The solids waste treatment system of aspect 1, wherein the pasteurizer comprises a length of tubing and one or more heaters configured to heat the slurry batch within the tubing.

Aspect 3. The solids waste treatment system of aspect 2, wherein the one or more heaters comprises a plurality of heaters having independent temperature control, each heater of the plurality of heaters wrapped around the length of tubing defining a heating zone for a section of tubing.

Aspect 4. The solids waste treatment system of any one of aspects 1-3, wherein the mechanical dewatering press comprises a filter assembly, a chamber, and a piston.

Aspect 5. The solids waste treatment system of aspect 4, wherein the mechanical dewatering press further comprises a filtrate outlet and a squeegee, wherein the squeegee is configured to remove the feces cake from the mechanical dewatering press.

Aspect 6. The solids waste treatment system of aspect 4 or 5, wherein the filter assembly of mechanical dewatering press comprises a filter screen.

Aspect 7. The solids waste treatment system of aspect 6, wherein the filter screen is a 41-160 μm nylon net or 140-508 μm stainless steel mesh.

Aspect 8. The solids waste treatment system of any one of aspects 1-7, wherein the drying tunnel dries the feces cake to a moisture content of 4-10%.

Aspect 9. The solids waste treatment system of any one of aspects 1-8, further comprising a disposal bin configured to receive and collect a batch of feces cakes.

Aspect 10. A process for treatment of human waste, the process comprising:
receiving, into a pasteurizer, a slurry batch comprising feces;
heating the slurry batch at an elevated temperature for a time period, the time period sufficient to kill pathogens producing a pathogen reduced slurry;
transferring the pathogen reduced slurry to a mechanical dewatering press;
compressing the pathogen reduced slurry in the mechanical dewatering press to separate a liquid phase from a volume reduced solid waste;
removing the liquid phase;
forming a feces cake from the volume reduced solid waste;
ejecting the volume reduced solid waste onto a conveyor; and
removing moisture from the volume reduced solid waste to form feces cake.

Aspect 11. The process for treatment of human waste of aspect 10, wherein removing moisture from the volume reduced solid waste comprises propelling forced air over the volume reduced solid waste on the conveyor to provide evaporative drying during transport in a drying tunnel.

Aspect 12. The process for treatment of human waste of aspect 10 or 11, wherein the volume reduced solid waste is about 20% or less of a volume of the slurry batch.

Aspect 13. The process for treatment of human waste of any one of aspects 10-12, wherein removing the liquid phase comprises transporting the liquid phase to a buffer tank system.

Aspect 14. The process for treatment of human waste of any one of aspects 10-13, wherein a volume of the slurry batch is about 100 mL.

Aspect 15. The process for treatment of human waste of any one of aspects 10-14, wherein the elevated temperature is at least 85° C.

Aspect 16. The process for treatment of human waste of any one of aspects 10-15, wherein the time period is about 10 minutes.

Aspect 17. The process for treatment of human waste of any one of aspects 10-16, wherein the feces cakes are dried to a moisture content of 4-10%.

Aspect 18. The process for treatment of human waste of any one of aspects 10-17, wherein the dried feces cakes have an E. coli count <100 per gram.

Aspect 19. The process for treatment of human waste of any one of aspects 10-18, further comprising transporting the feces cake to a disposal bin.

### Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Test Protocols

Moisture Content Determination in Solid Cakes Test Protocol: To determine moisture content, a solid feces cake sample or portion thereof is placed in a tared aluminum pan and the pan and sample are weighed on an analytical balance. The sample is dried at 105° C. for at least 2 hours and the pan and sample are again weighed on the analytical balance. The following equation can be used to determine moisture content:

$$moisture content ( \% ) = [ 1 - ( \frac{dry weight}{wet weight} ) ] \times 100 \%$$

E. coli Extraction from Solid Cakes: E. coli (colony forming units or CFUs) is extracted from feces cakes produced by the non-sewered single toilet system described herein according to the following procedure. In brief, sterile phosphate-buffered saline (PBS) is added to a cake and mixed well. Dry cakes will absorb some of the solution, but some liquid supernatant should also remain in the tube. This liquid can be used for biological testing as described below.

In order to achieve the lowest possible detection limit, a minimum volume of PBS is added in order to leave enough supernatant to remove for biological tests. Approximately 1 mL of supernatant is needed for E. coli detection using the E. coli Detection Test Protocol described below. If liquid is difficult to pipette, more PBS may be added.

To extract E. coli, a sterile solution of PBS is prepared. The feces cake, or portion thereof, to be tested is weighed. The weighed feces cake is placed into a sterile 50 mL centrifuge tube. 20 mL of sterile PBS is added to the centrifuge tube and thoroughly mixed using a vortexer until the cake is broken up. The sample is allowed to sit for 5-10 minutes so that large solid particles can settle. The sample is optionally centrifuged at 400 rpm for 10 minutes to assist settling of large particles. Centrifugation should not be carried out at higher rotation or E. coli will drop out of the supernatant.

The tube is held at a 45° angle, allowing the supernatant to pool for easy removal. If the amount of supernatant is insufficient for sampling, 10 mL of additional PBS can be added and vortexing and optional centrifugation can be repeated. A 1000 μL pipette tip is used to remove the supernatant, taking care to avoid large particles that can clog the pipette tip.

E. coli Detection Test Protocol: E. coli (colony forming units or CFUs) is measured for samples taken according to the “E. coli Extraction from Solid Cakes” procedure as described herein. E. coli CFUs can be measured by any technique known in the art. Herein, a PETRIFILM™ E. coli/coliform count plate from 3M™ Company (St. Paul, MN, US) was used. The PETRIFILM™ plate contains modified violet red bile (VRB) nutrients, a cold-water soluble gelling agent, 5-bromo-4-chloro-3-indolyl-D-glucuronide (BCIG, an indicator of glucuronidase activity), and a tetrazolium indicator for facilitating colony enumeration.

The sample is blended or homogenized with an appropriate sterile diluent such as Butterfield's phosphate buffered dilution water, 0.1% peptone water, peptone salt diluent, quarter-strength Ringer's solution, 0.85-0.90% saline solution, bisulfite-free letheen broth, or distilled water.

The PETRIFILM™ plate is placed on a flat surface. A top film on the plate is lifted. 1 mL of sample suspension prepared as described above is dispensed on the center of the plate's bottom film, using a pipette held perpendicular to the inoculation area. The top film is rolled down onto the sample without trapping air bubbles. A 3M™ PETRIFILM™ Spreader is used to spread the inoculum over the entire plate growth area. The spreader is removed and the plate is left undisturbed for at least one minute, allowing a gel to form.

Following gel formation, the plate is incubated horizontally in a stack of no more than 20 plates. Incubation time can vary and the ordinarily-skilled artisan can select an incubation time appropriate to a given application based on instructions supplied by the manufacturer. Following incubation, colonies on the plates can be counted using a standard colony counter or another illuminated magnifier. A typical incubation time for detecting E. coli and/or coliform bacteria is 18-24 hours at 37° C. Colonies appearing as blue to red-blue and associated with entrapped gas are to be counted as confirmed E. coli. Colonies should be counted within 1 hour of removal from the incubator or may be stored at −15° C. for up to one week prior to counting.

For extremely dense plates following incubation, the original sample may need to be diluted in order to obtain an accurate count, with appropriate volume corrections made based on the dilution volume.

To convert CFU per mL results from the PETRIFILM™ to CFU per dry gram, the following equation can be used, where total liquid volume refers to the total volume of PBS added to the initial feces cake or portion thereof:

$$\frac{C F U}{g} = count ( \frac{CFU}{mL} ) \times \frac{total liquid volume ( mL )}{dry mass of cake ( g )}$$

The features of the embodiments described herein are representative and, in alternative embodiments, certain features and elements can be added or omitted. It is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

1. A solids waste treatment system, comprising:
a pasteurizer configured to receive a slurry batch and heat the slurry batch at an elevated temperature for a time period to produce a pathogen free slurry, the slurry batch comprising at least feces;
a mechanical dewatering press configured to compress the pathogen free slurry to separate a liquid phase from a volume reduced solid waste, the volume reduced solid waste being formed into a feces cake;
an outlet to remove the liquid phase; and
a drying tunnel comprising a conveyor housed in an air duct system, the air duct system configured to propel forced air over the feces cake in the drying tunnel.

2. The solids waste treatment system of claim 1, wherein the pasteurizer comprises a length of tubing and one or more heaters configured to heat the slurry batch within the tubing.

3. The solids waste treatment system of claim 2, wherein the one or more heaters comprises a plurality of heaters having independent temperature control, each heater of the plurality of heaters wrapped around the length of tubing defining a heating zone for a section of tubing.

4. The solids waste treatment system of claim 1, wherein the mechanical dewatering press comprises a filter assembly, a chamber, and a piston.

5. The solids waste treatment system of claim 4, wherein the mechanical dewatering press further comprises a filtrate outlet and a squeegee, wherein the squeegee is configured to remove the feces cake from the mechanical dewatering press.

6. The solids waste treatment system of claim 4, wherein the filter assembly of mechanical dewatering press comprises a filter screen.

7. The solids waste treatment system of claim 6, wherein the filter screen is a nylon net or stainless-steel mesh.

8. The solids waste treatment system of claim 1, wherein the drying tunnel dries the feces cake to a moisture content of 4-10%.

9. The solids waste treatment system of claim 1, further comprising a disposal bin configured to receive and collect a batch of feces cakes.

10. A process for treatment of human waste, the process comprising:
receiving, into a pasteurizer, a slurry batch comprising feces;
heating the slurry batch at an elevated temperature for a time period, the time period sufficient to kill pathogens producing a pathogen reduced slurry;
transferring the pathogen reduced slurry to a mechanical dewatering press;
compressing the pathogen reduced slurry in the mechanical dewatering press to separate a liquid phase from a volume reduced solid waste;
removing the liquid phase;
forming a feces cake from the volume reduced solid waste;
ejecting the volume reduced solid waste onto a conveyor; and
removing moisture from the feces cake in a drying tunnel.

11. The process for treatment of human waste of claim 10, wherein removing moisture from the volume reduced solid waste comprises propelling forced air over the volume reduced solid waste on the conveyor to provide evaporative drying during transport in a drying tunnel.

12. The process for treatment of human waste of claim 10, wherein the volume reduced solid waste is about 20% or less of a volume of the slurry batch.

13. The process for treatment of human waste of claim 10, wherein removing the liquid phase comprises transporting the liquid phase to a buffer tank system.

14. The process for treatment of human waste of claim 10, wherein a volume of the slurry batch is about 100 mL.

15. The process for treatment of human waste of claim 10, wherein the elevated temperature is at least 85° C.

16. The process for treatment of human waste of claim 10, wherein the time period is about 10 minutes.

17. The process for treatment of human waste of claim 10, wherein the feces cakes are dried to a moisture content of 4-10%.

18. The process for treatment of human waste of claim 10, wherein the dried feces cakes have an E. coli count <100 per gram.

19. The process for treatment of human waste of claim 10, further comprising transporting the feces cake to a disposal bin.
